(19) United States
(12) Patent Application Publication
(10) Pub. No.: US 2014/0259390 A1
(43) Pub. Date: Sep. 18, 2014

(54) PATIENT LIFTING AND TRANSPORT DEVICE

(71) Applicant: Denver COUCH, West Chester, OH (US)

(72) Inventor: Denver COUCH, West Chester, OH (US)

(21) Appl. No.: 13/837,305

(22) Filed: Mar. 15, 2013

(51) Int. Cl. A61G 7/10

(52) U.S. Cl. CPC A61G 7/1007
USPC 5/83.1

(57) ABSTRACT

A transport device for assisting in the movement of patients, the transport device consisting essentially of a frame that includes a seat portion having a back edge and a back support portion having a bottom edge joined upright to the back edge of the seat portion, each portion being a planar, rigid material, and having a plurality of lift openings disposed through the seat portion and the back support portion, along each side edge and the top edge of the back support portion. The seat portion can have a seat opening in the general shape of a toilet bowl opening, and a removable covering plate configured to be removably placed over the seat opening. A comfort pad can be attached with mechanical fasteners to the top surface of the covering plate.

### FIELD OF THE INVENTION

The present invention relates to a device for lifting and transporting persons on limited mobility.

### BACKGROUND OF THE INVENTION

Persons of limited mobility, including persons requiring transport in wheelchairs, can require the assistance of other persons to get into and out of beds, into and out of the wheelchair, into and out of showers and tubs, and onto and off of toilets. The existing devices and techniques for lifting and transporting patients of limited mobility, typically with the assistance of hoists.

### SUMMARY OF THE INVENTION

The present invention provides transport device having a rigid, chair-like frame for assisting in the movement of patients into and out of a wheelchair and bed, and onto and off of a toilet. The frame includes a seat portion and a back support portion, each portion being in planar form, to the bottom of the back support portion joined to the back edge of the seat portion. The seat portion includes an passage opening for positioning over the bowl of a toilet when the patient requires. The seat opening is oval and in the general shape of a toilet bowl opening. Hand-hold openings are disposed through the seat portion and the back support portion along each side and the top edge of the back support portion, for lifting by assistants, or with a hoist apparatus, using straps, etc.

A removable covering plate can be placed over the seat opening, and a comfort pad can be attached to the top of the covering plate to add comfort to the bottom of the patient.

In an aspect of the invention, a transport device is provided for assisting in the movement of patients, the transport device consisting essentially of a frame that includes a seat portion having a back edge and a back support portion having a bottom edge joined upright to the back edge of the seat portion, each portion being a planar, rigid material, and having a plurality of lift openings disposed through the seat portion and the back support portion, along each side edge and the top edge of the back support portion. The seat portion can have a seat opening in the general shape of a toilet bowl opening, and a removable covering plate configured to be removably placed over the seat opening. A comfort pad can be attached with mechanical fasteners to the top surface of the covering plate.

### BRIEF DESCRIPTION OF THE FIGURES

FIG. 1 shows a perspective view of the transport device.

FIG. 2 is a left side elevation view of the transport device; the right side elevation view is a mirror image thereof.

FIG. 3 shows the transport device of FIG. 1 with a covering plate over the opening.

FIGS. 4a, 4b and 4c show alternative embodiments of a covering plate.

FIG. 5 shows a cross sectional view of the transport device with covering plate of FIG. 3 along line 5-5.

FIG. 6 shows the transport device with covering plate of FIG. 5, with a comfort pad covering the top surface of the covering plate.

FIG. 7 shows a front elevation view of the transport device of FIG. 1.

FIG. 8 shows a rear elevation view of the transport device of FIG. 1.

FIG. 9 shows a top plan view of the transport device of FIG. 1.

FIG. 10 shows a bottom plan view of the transport device of FIG. 1.

### DETAILED DESCRIPTION OF THE INVENTION

FIG. 1 shows a transport device 10 having a rigid seat portion 20 and a rigid back support portion 40 that is joined to the back edge of the seat portion at a fixed joint 61. The seat portion 20 and back support portion 40 can be made of the same planar material that is folded at the joint 61, or from separate materials that are affixed at the joint. Typical material is a panel of thermoplastic material, including, without limitation, polypropylene and high density polyethylene, typically from 10 to 20 mm thickness, sufficient to support the weight of an adult patient in use, and sufficient to remain rigid when the seat portion is slid under a patient lying on a bed or seated in a wheelchair.

The seat portion is substantially rectangular, and has an ovoid- or tear-drop-shaped passage opening 21 formed in the center. The upper edges of the opening are beveled to prevent snagging of the skin over the edge. At least one hand-hold opening 22, typically having rounded ends, is position at each lateral side near the front edge of the seat portion 20. Inboard of each hand-hold opening 22 is a strap opening 23 through which a nylon strap 24 can be threaded for securing the legs of the patient that extend over the front edge of the seat portion 20 during transport.

The back support portion 40 extends upward from the seat portion at a slight angle x for seated comforted. The back portion includes an upper portion 48 and a lower portion 49 that joins to the seat portion 20. At least one hand-hold opening(s) 42 and 45, typically having rounded ends, are position at each lateral side near the top edge of the back support portion 40, and/or near the top edge thereof. A centrally disposed upper hand-hold opening 46 is disposed at the top edge of the back support portion 40. Inboard of each hand-hold opening 42 is a strap opening 43 through which a nylon strap 44 can be threaded for securing the upper body or torso of the patient in the upright, seated position during transport.

The fixed joint 61 can be formed with the back support 40 extending upward from the seat portion 20 from a single planar material. After the shape of the portion is cut or stamped, the material along the joint 61 is heat to a plastic softening temperature sufficient to allow the back portion 40 to be bent at the joint 61 relative to the seat portion 20. An heated angled iron can also be impressed along the joint 61 line to melt the plastic material and create a v-shaped groove that is collapsed when the back support portion is folded upward. After cooling, the joint 61 provides a plastic weld of equivalent strength to the original planar material.

It is understood that the hand-hold openings are disposed a distance from the side edges of the seat portion and back support portion sufficient for structural integrity, to avoid breaking when an adult patient is lifted. It is also understood that lifting with a force F can be accomplished using conventional hoists.

As shown in FIG. 3, a removable covering plate 50 can be placed over the seat opening 21 to allow the patient more comfort during transport. FIGS. 4a, 4b and 4c shows three types of covering plates. The shape of the plates should be sufficient to cover the opening 21, and is illustrated as rectangular. Typically, the material of the covering plate is the same as for the transport device. To maintain the covering plate 50 in position over the opening 21, a rim 51 is provided on the underside 52. The rim includes outer edges that are configured to register with and engage the inner edges of the opening 21, to prevent the covering plate 50 from easily sliding away from over the opening 21 during use. The covering plate 50a has a solid-fill plate 51a that has a periphery that matches the periphery of the inner edge of the opening 21. Covering plate 50b has a ringed plate 51b that has extends in a closed track that matches the periphery of the inner edge of the opening 21. Covering plate 50c has a plurality of tabs 51c that are positioned spaced-apart along a periphery that matches the periphery of the inner edge of the opening 21.

FIG. 6 shows a comfort pad 65 can be attached to the upper side 53 of the covering plate 50 to aid comfort to the bottom of the patient. Mechanical fastener members 54, typically the hook members, are adhesively attached on the top surface 53 near the edges, and mating mechanical fastener elements, the hook material (not shown), are fastened to the bottom side 64 of a standard pad 65 in registry with the hook fastener elements 54. The comfort pad 65 can extend laterally beyond the side edges of the covering plate 50 to maximize comfort pad surface.

The transport device, also referred to as a lift patient wheelchair seat, is designed to fit beneath a patient seated in a wheelchair to enable caregivers to lift the patient from the wheelchair and place the patient in a seated position on a toilet, bed, exam table, etc. It can also be used to move a patient from a supine position to seated position in order to transport him to a wheelchair or other surface.

In the broadest aspects of the invention, the device can be made of a rigid or semi-rigid material such as plastic or wood. The handhold openings and straps can be placed at strategic locations on the device to allow caregivers the ability to grasp the device and lift the patient safely while in a stable, yet comfortable sitting position, to any other surface. The materials of the device, the seat covering and the pad are designed to be impervious to liquids and other bodily excretions, making for easier cleaning and improved sanitary conditions, over other similar devices such as canvas. The device can also be provided with lifting straps that are designed to attach to a hydraulic or manual lifting apparatus such as a Hoyer Lift for patients that may require mechanical lifting help.

The device may be used to move a supine patient to a sitting position by sliding the back of the unit beneath him, lifting his knees over the seat portion, applying safety straps and then lifting him to a sitting position.

The transport device is different from devices for the same purpose in numerous ways. Most devices for the same purpose are made of a flexible material such as canvas cloth which is very uncomfortable for the patient being lifted or transferred, which can cause injury to a patient as he is often squeezed and scrunched up like a sack of potatoes during lifting. Some canvas “slings” have an opening for the patient to use on a commode for going to the toilet. This often results in very unsanitary conditions as these devices are made from a cloth material making it difficult to clean up the patient and the device after body fluids and excretions may have soiled the area.

FIGS. 2 and 7-10 show the ornamental appearance of the transport device in various orthogonal views.

I claim:

1. A transport device for assisting in the movement of patients, the transport device consisting essentially of a frame that includes a seat portion having a back edge and a back support portion having a bottom edge joined upright to the back edge of the seat portion, each portion being a planar, rigid material, and having a plurality of lift openings disposed through the seat portion and the back support portion, along each side edge and the top edge of the back support portion.

2. The transport device according to claim 1, wherein the seat portion has a seat opening in the general shape of a toilet bowl opening.

3. The transport device according to claim 2, further including a removable covering plate configured to be removably placed over the seat opening.

4. The transport device according to claim 3, further including a comfort pad configured for attachment to a top surface of the covering plate.

5. The transport device according to claim 1, wherein the lift openings are hand-hold openings disposed toward the front edge of the seat portion on each side edge.

6. The transport device according to claim 5, wherein additional hand-hold openings are disposed toward the top edge of the back support portion on each side edge.

7. The transport device according to claim 7, wherein an additional hand-hold opening is disposed in the center of the top edge of the back support portion.

8. The transport device according to claim 1, further including a comfort pad configured for attachment to a top surface of the seat portion.

9. The transport device according to claim 8, wherein the comfort pad has mechanical fasteners to top surface of the seat portion.
